(19) United States
(12) Patent Application Publication
(10) Pub. No.: US 2004/0005377 A1
(43) Pub. Date: Jan. 8, 2004

(54) Mold for containers with handles and containers obtained therefrom

(76) Inventor: Jose Antonio Garcia Leal, San Gines (ES)

Correspondence Address: RUDEN, MCCLOSKY, SMITH, SCHUSTER & RUSSELL, P.A., P.O. BOX 1900, FORT LAUDERDALE, FL, 33301, US

(21) Appl. No.: 10/420,217

(22) Filed: Apr. 22, 2003

Related U.S. Application Data
(63) Continuation-in-part of application No. 09/620,295, filed on Jul. 20, 2000.

(30) Foreign Application Priority Data
Jul. 23, 1999 (EP) 99500125.2

(51) Int. Cl. B29C 45/26

(52) U.S. Cl. 425/542

(57) ABSTRACT

A mold for containers with handles is disclosed that includes a female mold, a male die, a detachable piece placed on the female mold together with a blocking detachable piece, and a detachable piece placed on the male die, forming a bin that has a peripheral skirt which has diametrically opposing perforations through which runs a connecting rod between a retention button and a handle, the separation of the handle from the bin not being possible; furthermore the peripheral skirt is joined to an upper rim of the bin of a horizontal segment having a void just above the retention point of the handle with the bin.

### CROSS-REFERENCE TO RELATED APPLICATIONS

This application is a continuation-in-part of U.S. patent application Ser. No. 09/620,295, filed on Jul. 20, 2000, entitled MOLD FOR CONTAINERS WITH HANDLES AND CONTAINERS BUILT WITH IT.

### TECHNICAL FIELD OF THE INVENTION

The present invention relates generally to molds for containers and more specifically to molds for containers with handles, as well as the containers obtained by said mold and split molds that facilitate the injection of containers with their respective handles.

### OBJECT OF THE INVENTION

The present invention is characterized in that a mold is obtained for the production of bins with the handle incorporated which in addition to the male and female pieces necessary for the formation of the bin, it has in addition two main pieces that favor the formation of the union between the handle and the bin, together with an accessory piece which serves for blocking one of the pieces which form the union between the handle and the aforementioned bin.

Through the mold of the present invention, a bin is obtained with a skirt which has the handle incorporated, the latter being formed so that it cannot be released from the bin.

The present invention is also characterized in that it allows the release of the pieces of the mold without the necessity to use any other hydraulic, pneumatic or mechanical system.

Likewise it is possible with the mold to obtain both large and small bins, given the simplicity and ease of construction.

Thus the present invention falls within the ambit of the procedures for manufacturing bins with handle incorporated.

### BACKGROUND OF THE INVENTION

Traditionally, molds used in the production of bins have numerous drawbacks. In some cases, it is necessary to use hydraulic, pneumatic or mechanical means to release the pieces that shape the bin, that is, in the de-molding process. In other situations, the number of pieces used is high.

Often it is necessary to form a holder appended to the rims of the bin with an opening through which the connecting rod passes between the handle restraining button and the actual handle of the bin.

In other cases the manufacturing procedure employed requires the use of recesses, fitments and pins that form the annular flank of the mold, the handle and the union of the bin to the handle in a single piece.

Therefore, the objective of the present invention is that of overcoming the above drawbacks, developing for this a manufacturing procedure together with some molds for said procedure which it presents, which avoids the employment of pneumatic, hydraulic or mechanical means for the de-molding process. It also avoids the formation of a holder appended externally on the rim of the bin wherein are housed the ends of the handle. Finally, the present invention avoids the employment of a large number of pieces, as only two pieces are used to form the mold for a bin with and incorporated handle.

### SUMMARY OF THE INVENTION

The object of the present invention of bin with handle incorporated, basically consists of a bin which has a peripheral skirt on the rim of the same, wherein diametrically opposing individual perforations have been formed through which runs a connecting rod between the handle and a handle retention button, all of which being implemented in a single process by injection.

The pieces used in the manufacturing procedure are, apart from a female piece and of a mold body of the extrusion plate, two pieces which are used to form the union between the handle and the bin, specifically they serve to form the connecting rod between the handle and the retention button, they also form the part of the peripheral skirt which lies directly in the area of the perforation through which the connecting rod is made to pass between the handle and the retention button.

The retention button is formed with voids that are both in the female mold piece and in the mold of the extrusion plate or male die.

Additionally a piece is used that serves as to block one of the pieces that serve for forming the union between the handle and the retention button. Both pieces are mounted on the male die.

### BRIEF DESCRIPTION OF THE DRAWINGS

To supplement the description made herein and with the object of assisting in a better understanding of the characteristics thereof, a set of accompanying figures of which, by way of illustration and not restrictively, the most significant details in the invention are represented.

FIG. 1 illustrates a side view of the general configuration of the bin obtained from the mold of the present invention.

FIG. 2 illustrates the bin of FIG. 1 in perspective view, together with a detail of the union between the bin and the handle.

FIG. 3 illustrates the top view of the bin obtained by the mold of the present invention together with a partially sectioned detail of the previous union.

FIG. 4 illustrates, in section form, the pieces used to form the union between the handle and the bin.

FIG. 5 illustrates a top view of the female mold, as well as the detail of the diametrically opposing voids that serve to house one of the pieces and its seal which form half of the union between the handle and the bin.

FIG. 6 illustrates a perspective view of the movable piece mounted on the female mold together with the movable piece for blocking.

FIGS. 7 and 8 illustrate perspective views of the movable piece arranged on the mold of the expulsion plate.

FIG. 9 illustrates a perspective view of the mold of the expulsion plate together with a detail wherein half of the handle retention button is formed.

FIG. 10 illustrates a sectioned form of the position of the open mold, including the arrangement of the pieces used in the formation of the bin with handle.

### PREFERRED EMBODIMENT OF THE INVENTION

In the light of the aforementioned figures, a preferred embodiment of the invention is described, together with the explanation of the drawings.

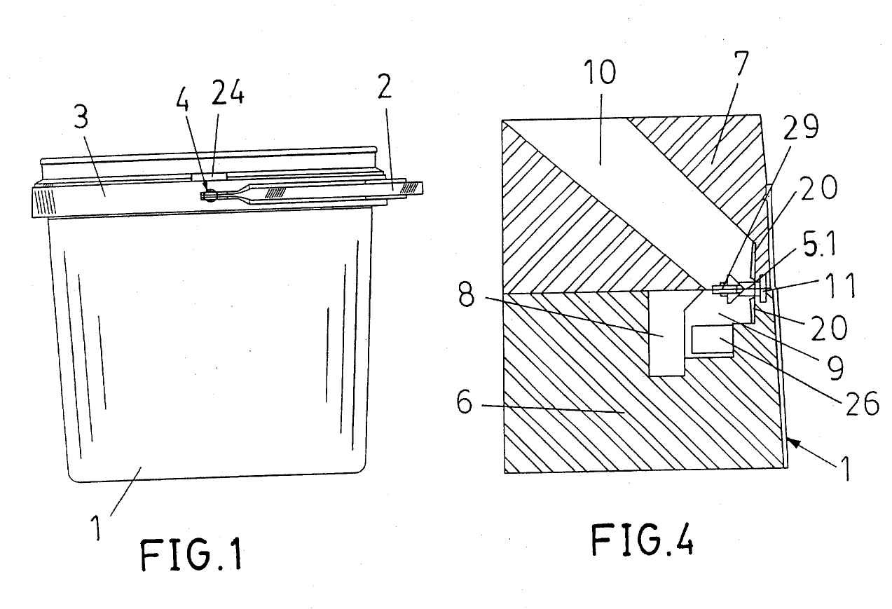

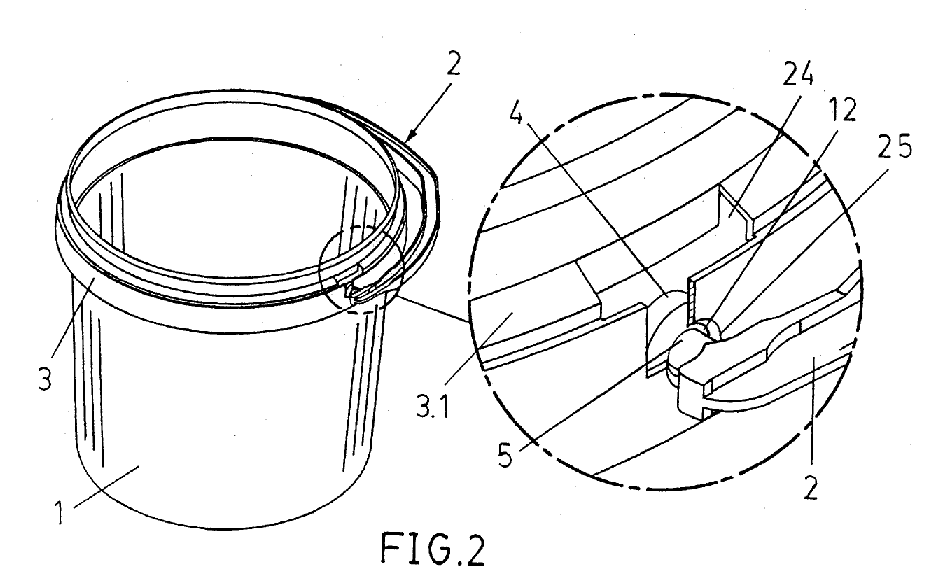

In FIG. 1, the constructive features can be observed in which the bin (1) includes a handle (2) hinged and retained in the peripheral skirt (3) by means of a retention button (4). The peripheral skirt (3) is joined to the upper rim of the bin (1) by means of a horizontal area (3.1) (as shown in FIG. 2).

Precisely positioned in the space immediately above the articulation and retention point of the handle (2) on the skirt (3) of the bin (1) there is a void (24), formed as a result of the constructive features of the bin.

In FIG. 2, it can be observed that in the space defined between the wall of the bin (1) and the skirt (3), the retention button (4) of the handle (2) is housed. In the area of the skirt (3), and specifically in the horizontal area (3.1) of the skirt (3), there is a void (24).

The retention button (4) and the handle (2) are joined by a connecting rod (5) that runs through a passing hole (25), located on the skirt (3), defining a space (12) wherein said connecting rod (5) is housed.

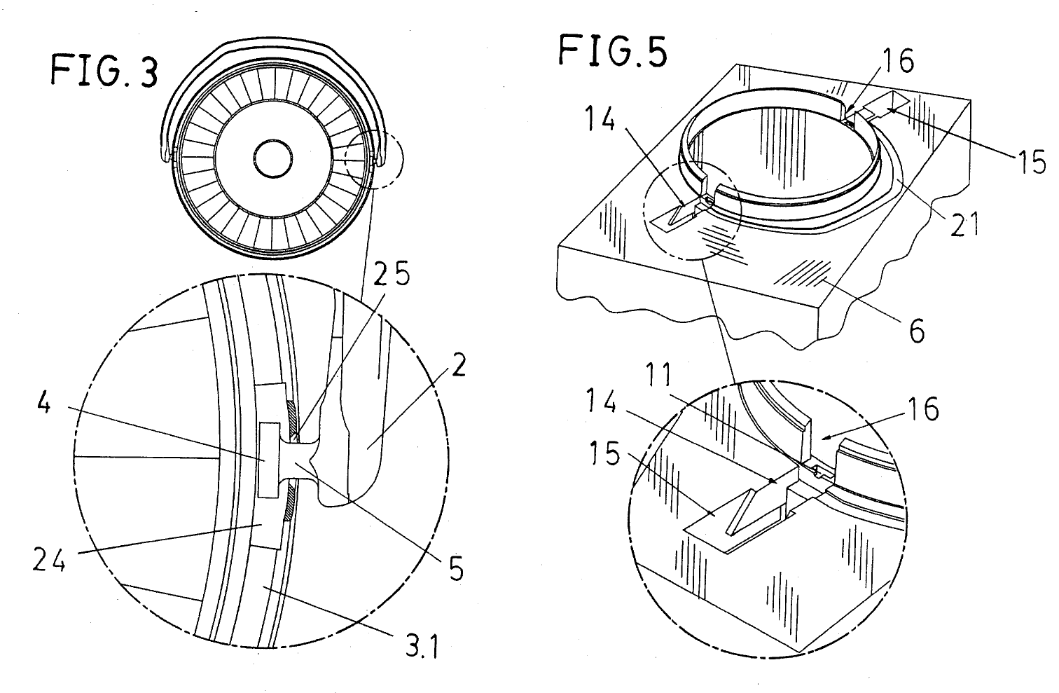

In FIG. 3, the top view of the bin, it can be observed that the horizontal part (3.1) of the skirt (3) is interrupted in the area of the void (24), which is positioned precisely above the perforation (25) along the skirt (3) through which passes the connecting rod (5) between the retention button (4) and the handle (2).

In FIG. 4, a female mold (6) is observed whereon are mounted the movable piece (8) and the blocking movable piece (9). The movable piece (9), in its upper part, has a series of recesses complementing others identically arranged on the movable piece (10) of the mold (7) of the expulsion plate.

The spaces defined between the movable pieces (9) and (10) are, on one hand, the space (5.1) that serves to form the connecting rod between the retention button (4) and the handle (2) and, on the other hand, the space (29) wherein the handle (2) is housed.

The body of the mold (7) of the extrusion plate and the body of the female mold (6) in contact with and nearest to the face conforming to the bin (1), and include two complementary lodgings (11) which conform to the retention button (4) joined to the connecting rod (5) between the handle and said button.

Furthermore, the detachable pieces (9) and (10) on the lateral face in union with the molds (6) and (7) define a space (20) where the skirt (3) is formed in the area of articulation of the handle.

In FIG. 5, the female mold (6) is shown having diametrically opposing and, in its upper part, recesses which define spaces. Housed in the space (14) is the detachable blocking piece (9), whilst in the space (15), the detachable piece (8) is housed. The cavity (21) is also observed wherein the handle is housed.

The female mold (6) has an upper rim (6.1) which, in the area of the recesses (14) and (15), presents a void (16) that allows the projection of the mold (7) of the expulsion plate to be housed, forming the retention button. Specifically, in the detail of the recess (11) there is a void (16) that, together with another similar recess of the mold (7) of the extrusion plate, forms the retention button (4).

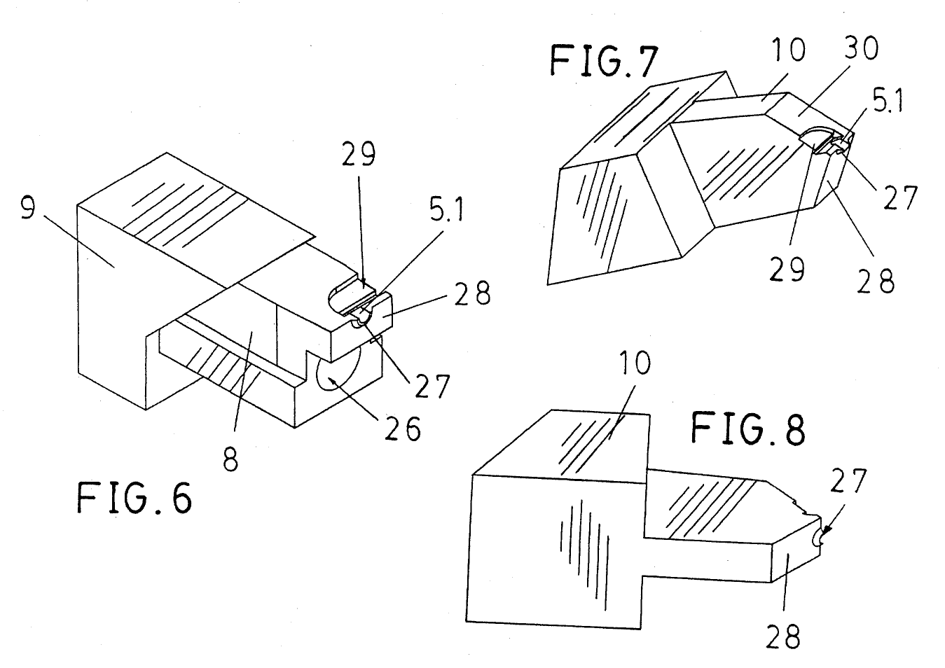

In FIG. 6 the detachable piece (8) together with the blocking detachable piece (9) can be observed. The detachable piece (9) has, on its face closest to the bin (1), a void (26) wherein a spring is housed, and on its top part a recess (29) for the lodging of the handle connected with a recess of semicircular section which defines a space (5.1), where together with a complementary space of the detachable piece (10), the connecting rod (5) is formed between the retention button (4) and the handle (2).

The detachable piece (9) has a protrusion (17) on the lateral face (28) and surrounding the recess that is defined by the space (5.1) that is positioned so that when said piece (9) is mounted in the female mold (6), a separation space (20) is defined (as shown in FIG. 4) which allows for the formation of the skirt (3) in that area.

The detachable piece has a shape that is approximately a parallelepiped, upon the rear part of which an inclined surface is defined that contacts the inclined surface of the blocking detachable piece (9).

In FIGS. 7 and 8, the detachable piece (10) is observed and is mounted on the mold (7), said piece being T-shaped wherein the end of the vertical segment is pointed, having two surfaces (28) and (30). The surface (30) has a recess (29) that forms the housing of the handle and is complementary to the recess (29) of the piece (9). It also has a semicircular recess in the end of the tip that defines a space (5.1) complementary to that of the piece (9) that serves to form the connecting rod (5). On the surface (28) and surrounding the perimeter of the recess of semicircular section, there is a protrusion (27) so that once said piece (10) is housed in the mold (7), it is kept separated from the mold (7) on said face defining a space (20) wherein the part of the skirt (3) corresponding to said area is formed.

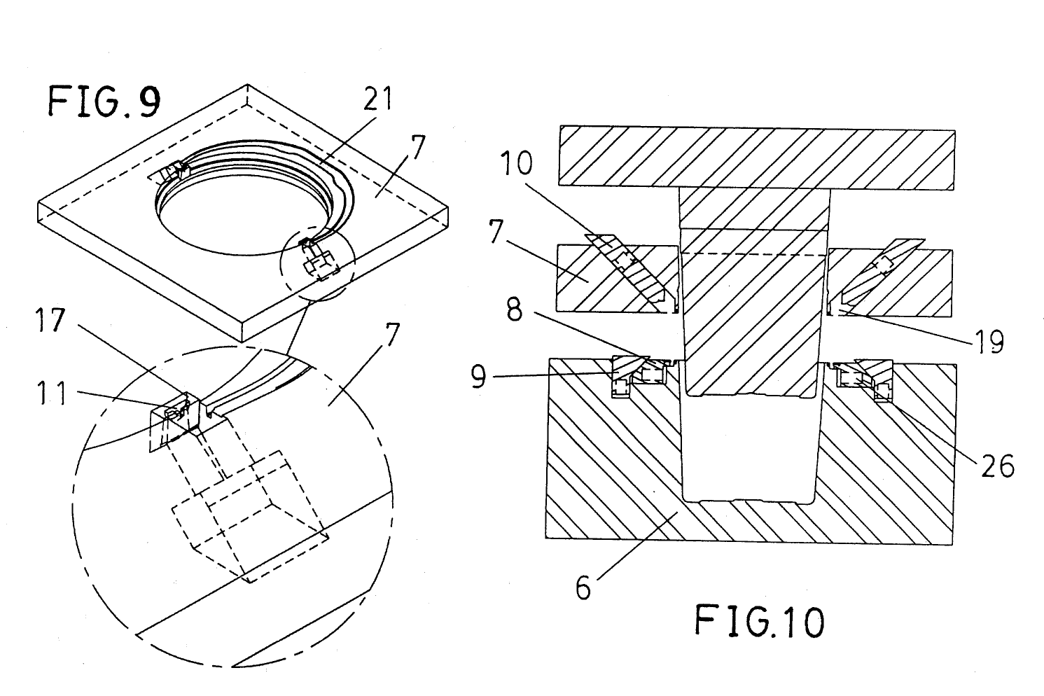

In FIG. 9, the body of the mold (7) of the extrusion plate, or male die, is shown with a cavity (21), complementary to that of the female mold (6), which serves to form the handle. Internally it has protuberances (17) which define the space (11), complementary to those of the female mold (6), wherein the retention button (4) of the handle is formed.

In FIG. 10, all the necessary pieces of the mold to form the bin are observed, that is, the female mold (6), the mold (7) of the extrusion plate or male die, the detachable piece (8), together with the blocking detachable piece (9), and the detachable piece (10) housed in the space (19) defined in the mold (7).

Although only a few exemplary embodiments of the present invention have been described in detail above, those skilled in the art will readily appreciate that numerous modifications are to the exemplary embodiments are possible without materially departing from the novel teachings and advantages of this invention. Accordingly, all such modifications are intended to be included within the scope of this invention as defined in the following claims.

What is claimed is:

1. A mold for containers having handles, comprising: a female mold, a mold of an extrusion plate, a detachable piece housed in said female mold, a detachable piece housed in said mold of said extrusion plate, and a blocking detachable piece which is operatively arranged with said detachable piece of the female mold and wherein the employment of de-molding by mechanical, hydraulic or pneumatic means is not required.

2. The mold for containers with handles according to claim 1, wherein said female mold further includes diametrically opposing hollows housing said blocking detachable piece, a peripheral rim having a void in the top part of which are recesses defining a space wherein a retention button of said handle is formed, and having a cavity wherein said handle is formed.

3. The mold for containers with handles according to claim 1, wherein said detachable piece housed in said female mold has on its face nearest to said bin a hollow wherein a spring is housed, and on its top part a recess for housing said handle connected with a recess of semicircular section which defines a space where, together with a complementary space of said blocking detachable piece, said connecting rod is formed between said retention button and said handle.

4. The mold for containers with handles according to claim 1, wherein said blocking detachable piece is T-shaped, wherein the end of the vertical segment is pointed, defending two surfaces, one surface having a recess which forms a lodging for said handle and is complementary to said recess and wherein a semicircular recess in the end of the tip defines a space complementary to that of said piece to form said connecting rod, the other surfacing having a protrusion so that when said blocking detachable piece is housed in said mold of said extrusion plate it is separated from said mold on a face defining a space wherein a portion of said skirt corresponding to this area is formed.

5. The mold for containers with handles according to claim 1, wherein body of said mold of said extrusion plate, has a cavity complementary to that of said female mold to form said handle, and wherein internally it has protuberances which define a space complementary to that of said female mold, wherein said retention button of said handle is formed.

6. The mold for containers with handles according to claim 1, wherein said blocking detachable piece is arranged on the mold having an inclined surface which contacts an inclined surface of said detachable piece.

7. A containers obtained by a mold comprising a bin having an uninterrupted peripheral skirt joined to a top part of said bin by a horizontal segment of said skirt, said horizontal segment having a void, said skirt having a perforation which defines a space through which runs a connecting rod between a retention button and a handle, said retention button housed between a rim of said bin and said peripheral skirt with no possibility of release.
